(19) United States
(12) Patent Application Publication
(10) Pub. No.: US 2026/0220733 A1
(43) Pub. Date: Jul. 30, 2026

(54) CAR SHARING SYSTEM AND CONTROL DEVICE

(71) Applicant: TOYOTA JIDOSHA KABUSHIKI KAISHA, Toyota-shi (JP)

(72) Inventors: Ryosuke TANIMURA, Nagoya-shi (JP); Hiroki TAKEISHI, Tokyo (JP); Reina YAMAMURA, Nagoya-shi (JP)

(73) Assignee: TOYOTA JIDOSHA KABUSHIKI KAISHA, Toyota-shi (JP)

(21) Appl. No.: 19/428,637

(22) Filed: Dec. 22, 2025

(30) Foreign Application Priority Data
Jan. 27, 2025 (JP) 2025-011565

(51) Int. Cl. G06Q 50/43; G01S 5/02; H04W 4/021; H04W 4/029; H04W 4/40

(52) U.S. Cl. CPC G06Q 50/43; G01S 5/0231; H04W 4/021; H04W 4/029; H04W 4/40

(57) ABSTRACT

A car sharing system according to the present disclosure includes: a return determination information acquisition device that acquires pieces of return determination information including position information of a vehicle jointly used among users registered in advance, the position information being used for a return determination of the vehicle to a car station; a storage device that stores return determination conditions corresponding to the pieces of return determination information; and a control device that acquires the pieces of return determination information from the return determination information acquisition device, acquires the return determination conditions from the storage device, and performs, based on the pieces of return determination information and the return determination conditions, the return determination of the vehicle to the car station, in which the control device determines that the vehicle has been returned to the car station when any of the return determination conditions is determined to be satisfied.

### CROSS-REFERENCE TO RELATED APPLICATION

This application claims priority to Japanese Patent Application No. 2025-011565 filed on January 27, 2025. The disclosure of the above-identified application, including the specification, drawings, and claims, is incorporated by reference herein in its entirety.

### BACKGROUND

### Technical Field

The present disclosure relates to a car sharing system and a control device.

### Description of Related Art

Japanese Unexamined Patent Application Publication No. 2021-086170 (JP 2021-086170 A) discloses a car sharing service in which a vehicle (car sharing vehicle) that is jointly used among members registered in advance is rented out and returned to a car station. In such a car sharing service, for example, a return determination to the car station is performed at the time of return of the vehicle using position information of the vehicle acquired by GPS. More specifically, for the car sharing system, a geofence corresponding to the car station is manually set in advance by an administrator. Then, based on the position information of the vehicle acquired by GPS, the return determination is performed depending on whether the vehicle to be returned has entered the geofence.

### SUMMARY

However, the accuracy of the position information of the vehicle acquired by GPS varies depending on the surrounding environment of the vehicle. In addition, since the geofence is set by the administrator based on an experience rule or the like of the administrator, the return determination of the vehicle may not be correctly performed.

The present disclosure has been made in view of the problems described above, and an object thereof is to provide a car sharing system and a control device capable of improving the accuracy of the return determination of the vehicle.

In order to solve the problems described above and to achieve the object, a car sharing system according to the present disclosure includes:

a return determination information acquisition device configured to acquire a plurality of pieces of return determination information including position information of a vehicle that is jointly used among users registered in advance, the position information being used for a return determination of the vehicle to a car station;

a storage device configured to store a plurality of return determination conditions corresponding to the pieces of return determination information; and

a control device configured to acquire the pieces of return determination information from the return determination information acquisition device, to acquire the return determination conditions from the storage device, and to perform, based on the pieces of return determination information and the return determination conditions, the return determination of the vehicle to the car station,

in which the control device is configured to determine that the vehicle has been returned to the car station when any of the return determination conditions is determined to be satisfied.

As a result, the car sharing system according to the present disclosure can improve the accuracy of the return determination of the vehicle by using the pieces of return determination information including the position information of the vehicle.

In addition, a control device according to the present disclosure is configured to perform a return determination of a vehicle that is jointly used among users registered in advance to a car station, using a plurality of pieces of return determination information including position information of the vehicle, the position information being used for the return determination of the vehicle to the car station.

As a result, the control device according to the present disclosure can improve the accuracy of the return determination of the vehicle by using the pieces of return determination information including the position information of the vehicle.

In addition, in the above, the pieces of return determination information may include information related to a connection between a charging device installed at the car station and the vehicle, and when the charging device and the vehicle are connected, the vehicle may be determined to have been returned to the car station.

As a result, the accuracy of the return determination of the vehicle can be improved by using information indicating that the charging device installed at the car station and the vehicle are connected, as the pieces of return determination information.

In addition, in the above, the pieces of return determination information may include information related to a connection between a beacon installed at the car station and either an in-vehicle device mounted in the vehicle or a portable information terminal associated with the vehicle, and

when the beacon and either the in-vehicle device or the portable information terminal are connected, the vehicle may be determined to have been returned to the car station.

As a result, the accuracy of the return determination of the vehicle can be improved by using information indicating that the beacon installed at the car station and either the in-vehicle device or the portable information terminal associated with the vehicle are connected, as the pieces of return determination information.

In addition, in the above, the pieces of return determination information may include information related to past vehicle position information acquired by a positioning unit provided in the vehicle, and a direction of movement of the vehicle, and

based on the past vehicle position information and the direction of movement of the vehicle, when the vehicle is estimated to be within the car station at a time of return of the vehicle, the vehicle may be determined to have been returned to the car station.

As a result, the accuracy of the return determination of the vehicle can be improved by using information indicating that the vehicle is estimated to be within the car station at the time of return of the vehicle based on the past vehicle position information and the direction of movement of the vehicle, as the pieces of return determination information.

In addition, in the above, the pieces of return determination information may include position information of a portable information terminal associated with the vehicle, and

when the position information of the portable information terminal is within the car station, the vehicle may be determined to have been returned to the car station.

As a result, the accuracy of the return determination of the vehicle can be improved by using information indicating that the position information of the portable information terminal associated with the vehicle is within the car station, as the pieces of return determination information.

The car sharing system and the control device according to the present disclosure have an effect of improving the accuracy of the return determination of the vehicle by using the pieces of return determination information including the position information of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a car sharing system according to an embodiment; and

FIG. 2 is a flowchart showing an example of a return determination control performed by a controller of a management device according to the embodiment.

### DETAILED DESCRIPTION OF EMBODIMENTS

Hereinafter, embodiments of the car sharing system and the control device according to the present disclosure will be described. The disclosure is not limited to the embodiments.

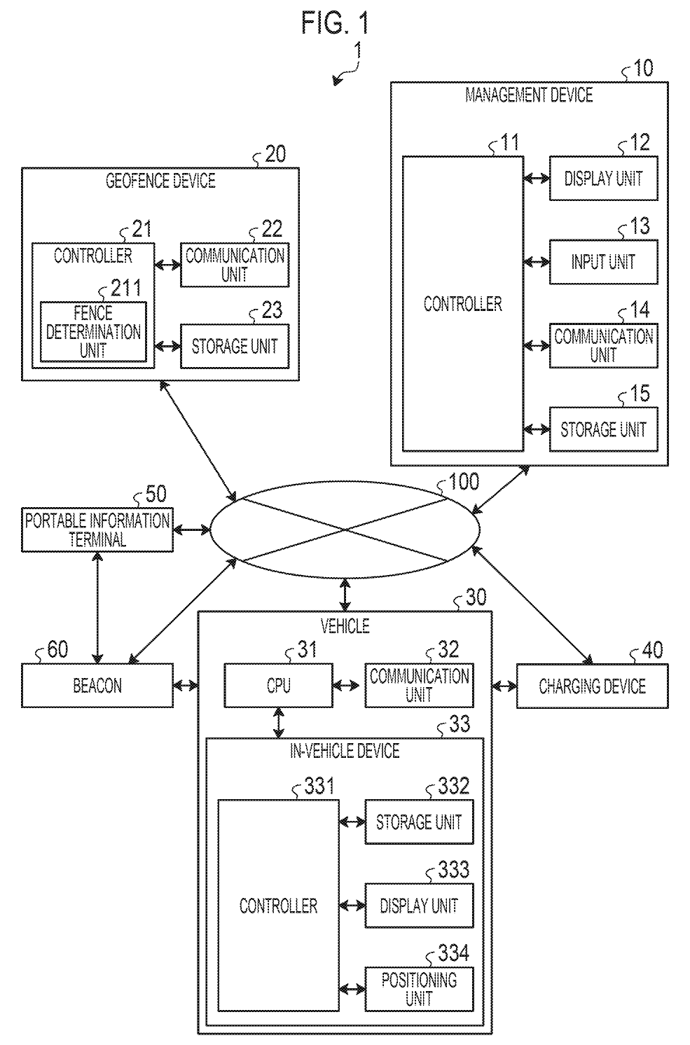

FIG. 1 is a diagram showing a schematic configuration of a car sharing system 1 according to the embodiment.

As shown in FIG. 1, the car sharing system 1 according to the embodiment is configured by a management device 10, a geofence device 20, a vehicle 30, a charging device 40, a portable information terminal 50, a beacon 60, and the like. In addition, in FIG. 1, solely one vehicle 30 is shown, but the vehicle 30 may be a plurality of vehicles.

The management device 10, the geofence device 20, the vehicle 30, the charging device 40, the portable information terminal 50, and the beacon 60 all include a communication function and are configured to communicate with each other through a network 100. The network 100 is configured by, for example, a public communication network such as an Internet line network or a mobile telephone network.

The management device 10 is a device for performing processing related to management of a car sharing service in which the vehicle 30 that is jointly used among members registered in advance is rented out and returned to a car station. The management device 10 is realized by, for example, a general-purpose computer such as a workstation or a personal computer.

As shown in FIG. 1, the management device 10 includes a controller 11, a display unit 12, an input unit 13, a communication unit 14, and a storage unit 15. The controller 11 includes, for example, a processor such as a central processing unit (CPU) and a memory (main storage unit) consisting of a random access memory (RAM), a read only memory (ROM), and the like. The controller 11 loads and executes a program stored in the storage unit 15 in a work area of the memory (main storage unit), and controls each configuration unit and the like through the execution of the program to realize a function that matches a predetermined purpose.

The display unit 12 is configured by, for example, a liquid crystal display (LCD), an organic EL display (OLED), or the like, and based on control by the controller 11, displays various types of information for reference by an administrator. It should be noted that the term "administrator" refers to a person who manages the car sharing service.

The input unit 13 is configured by a touch panel or the like having an input function of receiving an operation by a finger, a pen, or the like of the administrator.

In the present embodiment, the display unit 12 and the input unit 13 are integrally configured by a touch panel display or the like having a display function of displaying various types of information based on the control by the controller 11 and an input function of receiving an operation by a finger, a pen, or the like of the administrator.

The communication unit 14 is configured by, for example, a local area network (LAN) interface board, a wireless communication circuit for wireless communication, and the like. The communication unit 14 is connected to the network 100 by wire or wirelessly, and performs communication with the geofence device 20, the vehicle 30, the charging device 40, the portable information terminal 50, and the beacon 60.

The storage unit 15 is configured by a recording medium such as a hard disk drive (HDD). The storage unit 15 is configured to store an operating system (OS), various programs, various tables, various databases, and the like. In addition, the storage unit 15 stores, for example, fence setting information including information related to a range of the geofence and the like. In addition, the storage unit 15 stores vehicle position information and the like as necessary in addition to the fence setting information through the network 100.

The geofence device 20 is a device for performing processing related to a geofence for setting a returnable range of the vehicle 30 for a car station where the vehicle 30 is rented out and returned. The geofence device 20 is realized by, for example, a general-purpose computer such as a workstation or a personal computer.

As shown in FIG. 1, the geofence device 20 includes a controller 21, a communication unit 22, and a storage unit 23. The controller 21 functions as a fence determination unit 211 through the execution of a program stored in the storage unit 23. The communication unit 22 can perform communication with the management device 10, the vehicle 30, the charging device 40, the portable information terminal 50, and the beacon 60 by being connected to the network 100 by wire or wirelessly. In addition, the storage unit 23 stores, for example, fence information including a range in which the geofence is set for the car station. The controller 21 transmits, for example, the fence information stored in the storage unit 23 to the management device 10 through the network 100 from the communication unit 22.

The fence determination unit 211 determines, for example, whether the vehicle 30 has entered the geofence set for the car station as a return destination. The fence determination unit 211 collects position information of the vehicle 30 (hereinafter, referred to as "vehicle position information") from the vehicle 30 through the network 100. Subsequently, the fence determination unit 211 determines, based on the vehicle position information and the fence information stored in the storage unit 23, whether the vehicle 30 has entered the geofence set for the car station as the return destination. Then, the fence determination unit 211 outputs fence determination information that is information related to whether the vehicle 30 has entered the geofence, to the management device 10 through the network 100 from the communication unit 22. When the vehicle 30 has entered the geofence and when the vehicle 30 has exited the geofence, the fence determination unit 211 transmits the fence determination information indicating the fact to the management device 10.

The vehicle 30 is a car sharing vehicle that is jointly used among members registered in advance for the car sharing service. The vehicle 30 is a movable object that is communicable with the outside, and an engine-driven vehicle, an electrified vehicle, or the like can be used. In addition, the vehicle 30 may be either a manually driven vehicle or an automated driving vehicle.

As shown in FIG. 1, the vehicle 30 includes an electronic control unit (ECU) 31, a communication unit 32, and an in-vehicle device 33. The ECU 31 comprehensively controls the operations of various components mounted in the vehicle 30. The communication unit 32 is configured by, for example, a data communication module (DCM) or the like. The communication unit 32 can perform communication with the management device 10, the geofence device 20, the charging device 40, the portable information terminal 50, and the beacon 60 via wireless communication through the network 100.

The in-vehicle device 33 includes a controller 331, a storage unit 332, a display unit 333, and a positioning unit 334. The controller 331 controls the display unit 333, the positioning unit 334, and the like through the execution of a program stored in the storage unit 332.

The display unit 333 is configured by, for example, a liquid crystal display (LCD), an organic EL display (OLED), or the like, and displays various types of information to a user based on the control by the controller 331. It should be noted that the term "user" refers to an occupant of the vehicle 30 including a driver. In addition, the display unit 333 may be configured by a touch panel display or the like having an input function of receiving an operation by a finger, a pen, or the like of the user and a display function of displaying various types of information based on the control by the controller 331.

The positioning unit 334 receives, for example, radio waves from a global positioning system (GPS) satellite and detects the vehicle position information. The positioning unit 334, controlled by the controller 331, outputs the detected vehicle position information to the management device 10 through the network 100 from the communication unit 32.

The charging device 40 supplies power to the vehicle 30 and is used to charge a battery (not shown) mounted in the vehicle 30. The charging device 40 is provided in, for example, a car station where the vehicle 30 is rented out and returned. The charging device 40 may be configured using either a contact charging method or a non-contact charging method, and corresponds to the charging method of the vehicle 30 that is rented out and returned to the car station. The charging device 40 is configured to perform wired communication or wireless communication with the vehicle 30 by a communication unit (not shown). In addition, the charging device 40 transmits, for example, charging information related to the current charging device 40 to the management device 10 through the network 100 from a communication unit (not shown), sequentially or at predetermined intervals. The charging information related to the current charging device 40 includes, for example, connection information indicating that the vehicle 30 and the charging device 40 are electrically connected to each other so that charging is possible.

The portable information terminal 50 is an information processing device that can be carried by the user, such as a smartphone owned by the user. The portable information terminal 50 is associated with the vehicle 30 when the user uses the car sharing service. Information related to the association between the portable information terminal 50 and the vehicle 30 is output to the management device 10 through the network 100 and is stored in the storage unit 15 of the management device 10 or the like.

The beacon 60 is a fixed sensor device that can be connected to the in-vehicle device 33 of the vehicle 30 or the portable information terminal 50 via bidirectional communication using Bluetooth (registered trademark) or the like. The beacon 60 outputs a vehicle detection signal indicating that the vehicle 30 has been detected, for example, each time the vehicle 30 returned to the car station is detected, to the management device 10 through the network 100.

Here, in the car sharing system 1 according to the embodiment, the communication unit 14 of the management device 10 functions as the return determination information acquisition device. The return determination information acquisition device acquires a plurality of pieces of return determination information including position information of the vehicle 30 used for the return determination of the vehicle 30 to the car station. In addition, the storage unit 15 of the management device 10 functions as the storage device that stores a plurality of return determination conditions corresponding to the pieces of return determination information. In addition, the controller 11 of the management device 10 acquires the pieces of return determination information from the communication unit 14, acquires the return determination conditions from the storage unit 15, and functions as the control device that executes the return determination of the vehicle 30 to the car station based on the pieces of return determination information and the return determination conditions.

In the car sharing system 1 according to the embodiment, the controller 11 of the management device 10 refers to the highly reliable return determination information by combining the return determination conditions in a case of performing the return determination of the vehicle 30 to the car station. It should be noted that the pieces of return determination information include information related to a connection between the charging device 40 installed at the car station and the vehicle 30. In addition, the pieces of return determination information include information related to a connection between the beacon 60 installed at the car station and either the in-vehicle device 33 mounted in the vehicle 30 or the portable information terminal 50 associated with the vehicle 30. In addition, the pieces of return determination information include information related to vehicle position information (GPS position information) acquired by GPS and the fence information. In addition, the pieces of return determination information include information related to past vehicle position information by the positioning unit 334 provided in the vehicle 30 and the direction and time of movement of the vehicle 30. In addition, the pieces of return determination information include position information of the portable information terminal 50 associated with the vehicle 30. As a result, in the car sharing system 1 according to the embodiment, the accuracy of the return determination of the vehicle 30 by the controller 11 of the management device 10 can be improved.

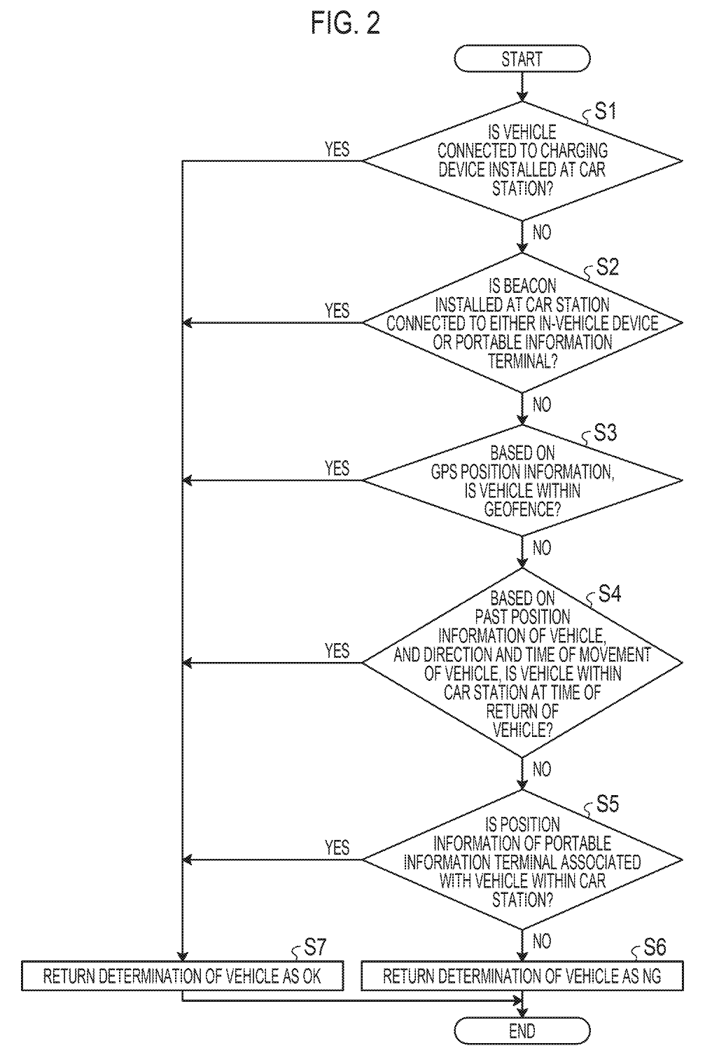

FIG. 2 is a flowchart showing an example of a return determination control performed by a controller 11 of a management device 10 according to the embodiment. The return determination control shown in FIG. 2 is executed at a timing when the management device 10 receives a signal indicating that the vehicle 30 has been returned through the network 100. The signal indicating that the vehicle 30 has been returned is received by the management device 10, for example, when the user presses a return completion button provided in the vehicle 30 or the portable information terminal 50.

In the car sharing system 1 according to the embodiment, the controller 11 of the management device 10 performs the return determination in order from S1 to S5 of the flowchart shown in FIG. 2. When any of the conditions of S1 to S5 is satisfied, the controller 11 of the management device 10 determines that the return determination of the vehicle 30 is OK. On the other hand, when none of the conditions of S1 to S5 is satisfied, the controller 11 of the management device 10 determines that the return determination of the vehicle 30 is NG.

First, the controller 11 of the management device 10 determines whether the vehicle 30 is connected to the charging device 40 installed at the car station as the return destination (S1). When the controller 11 of the management device 10 determines that the vehicle 30 is connected to the charging device 40 set at the car station as the return destination (YES in S1), the return determination of the vehicle 30 is determined to be OK (S7), and the series of return determination controls is ended. For example, the vehicle 30 may be an electrified vehicle capable of contact charging, the charging device 40 may employ a contact charging method, and a charging connector of the charging device 40 may be fitted into a charging inlet of the vehicle 30 so as to be electrically connected. In this case, the return determination of the vehicle 30 is determined to be OK. In addition, for example, the vehicle 30 may be an electrified vehicle capable of non-contact charging, the charging device 40 may employ a non-contact charging method, and the charging device 40 and the vehicle 30 may be connected by being paired through communication. In this case, the return determination of the vehicle 30 is determined to be OK. When the vehicle 30 is an electrified vehicle, the return determination can be performed most reliably based on the condition S1.

On the other hand, when the controller 11 of the management device 10 determines that the vehicle 30 is not connected to the charging device 40 set at the car station as the return destination (NO in S1), the process proceeds to S2.

Next, the controller 11 of the management device 10 determines whether the beacon 60 installed at the car station as the return destination and either the in-vehicle device 33 mounted in the vehicle 30 or the portable information terminal 50 associated with the vehicle 30 are connected (S2). When the controller 11 of the management device 10 determines that the beacon 60 and either the in-vehicle device 33 or the portable information terminal 50 are connected (YES in S2), the return determination of the vehicle 30 is determined to be OK (S7), and the series of return determination controls is ended. For example, there may be a car station surrounded by high-rise buildings where the accuracy of the vehicle position information acquired by GPS is poor. In this case and the like, the return determination of the vehicle is determined to be OK on the condition that the beacon 60 and either the in-vehicle device 33 or the portable information terminal 50 are connected via bidirectional communication. In addition, when an appropriate geofence cannot be set at the car station, the controller 11 of the management device 10 may display, on the display unit 12, information recommending the introduction of the return determination mechanism used in S2 to notify the administrator.

On the other hand, when the controller 11 of the management device 10 determines that the beacon 60 and either the in-vehicle device 33 or the portable information terminal 50 are not connected (NO in S2), the process proceeds to S3.

Next, the controller 11 of the management device 10 determines, based on the vehicle position information (GPS position information) detected by the positioning unit 334 of the vehicle 30, whether the vehicle 30 is within the geofence for the car station as the return destination (S3). When the controller 11 of the management device 10 determines that the vehicle 30 is within the geofence for the car station as the return destination (YES in S3), the return determination of the vehicle 30 is determined to be OK (S7), and the series of return determination controls is ended. For example, the controller 11 of the management device 10 may determine, based on the vehicle position information (GPS position information) acquired by GPS and the fence information, that the vehicle position information is within the geofence set in advance at the car station as the return destination. In this case, the controller 11 of the management device 10 determines that the return determination of the vehicle 30 is OK.

On the other hand, when the controller 11 of the management device 10 determines that the vehicle 30 is not within the geofence for the car station as the return destination (NO in S3), the process proceeds to S4.

Next, the controller 11 of the management device 10 determines, based on the past vehicle position information and the direction and time of movement of the vehicle 30, whether the vehicle 30 is within the car station at the time of return of the vehicle 30 (S4). When the controller 11 of the management device 10 determines, based on the past vehicle position information and the direction and time of movement of the vehicle 30, that the vehicle 30 is within the car station at the time of return of the vehicle 30 (YES in S4), the return determination of the vehicle 30 is determined to be OK (S7). Then, the controller 11 of the management device 10 ends the series of return determination controls. For example, the controller 11 of the management device 10 estimates, based on the past position information of vehicle 30 acquired by GPS and the direction and time of movement of the vehicle 30, whether the vehicle 30 is within the car station at the time of return of the vehicle 30, in addition to the latest vehicle position information of the vehicle 30 acquired by GPS. This estimation is performed, for example, in the same manner as estimation of the vehicle position information inside a tunnel in a general car navigation system. Then, when it is estimated that the vehicle 30 is within the car station at the time of return of the vehicle 30, the return determination of the vehicle 30 is determined to be OK.

On the other hand, when the controller 11 of the management device 10 determines, based on the past vehicle position information and the direction and time of movement of the vehicle 30, that the vehicle 30 is not within the car station at the time of return of the vehicle 30 (NO in S4), the process proceeds to S5.

Next, the controller 11 of the management device 10 determines whether the position information of the portable information terminal 50 associated with the vehicle 30 is within the car station as the return destination (S5). When the controller 11 of the management device 10 determines that the position information of the portable information terminal 50 associated with the vehicle 30 is within the car station as the return destination (YES in S5), the return determination of the vehicle 30 is determined to be OK (S7), and the series of return determination controls is ended. For example, the controller 11 of the management device 10 determines that the return determination of the vehicle 30 is OK on the condition that the portable information terminal 50 (smartphone or the like of the user) associated with the vehicle 30 is within the car station based on the position information of the portable information terminal 50 associated with the vehicle 30.

On the other hand, when the controller 11 of the management device 10 determines that the position information of the portable information terminal 50 associated with the vehicle 30 is not within the car station as the return destination (NO in S5), the return determination of the vehicle 30 is determined to be NG (S6). Then, the controller 11 of the management device 10 ends the series of return determination controls. That is, when the controller 11 of the management device 10 determines NO for all of the conditions of S1 to S5, the vehicle 30 is considered not returned to the car station as the return destination, and the return determination of the vehicle 30 is determined to be NG.

For example, when a gate that can be opened and closed is provided at an entrance of a parking lot where the car station as the return destination is provided, the following condition may be adopted instead of the condition of S2 shown in FIG. 2. That is, the controller 11 of the management device 10 uses information indicating that the vehicle 30 has passed through a gate provided at an entrance of the parking lot as the return determination information of the vehicle 30 to the car station as the return destination. Examples of the information indicating that the vehicle 30 has passed through the gate include information related to a license plate of the vehicle 30 captured by a camera installed near the gate and information related to reading of a parking lot periodic ticket or a parking card by a reader installed near the gate. Then, when the controller 11 of the management device 10 determines that the vehicle 30 has passed through the gate, the vehicle 30 is estimated to have been returned to the car station as the return destination, and the return determination of the vehicle 30 is determined to be OK. On the other hand, when the controller 11 of the management device 10 determines that the vehicle 30 has not passed through the gate, the vehicle 30 is estimated not to have been returned to the car station as the return destination, and the return determination of the vehicle 30 is determined to be NG.

In addition, the management device 10 may store, in the storage unit 15, information used for the return determination corresponding to each of the conditions of S1 to S5. Then, when the user presses the return completion button or the like to indicate that the vehicle 30 has been returned, the controller 11 of the management device 10 may perform the return determination of the vehicle 30 by using the information related to the return determination stored in the storage unit 15.

As described above, in the car sharing system 1 according to the embodiment, the controller 11 of the management device 10 refers to the highly reliable return determination information by combining the return determination conditions in a case of performing the return determination of the vehicle 30 to the car station as the return destination. As a result, in the car sharing system 1 according to the embodiment, the accuracy of the return determination of the vehicle 30 by the controller 11 of the management device 10 can be improved.

What is claimed is:

1. A car sharing system comprising:
a return determination information acquisition device configured to acquire a plurality of pieces of return determination information including position information of a vehicle that is jointly used among users registered in advance, the position information being used for a return determination of the vehicle to a car station;
a storage device configured to store a plurality of return determination conditions corresponding to the pieces of return determination information; and
a control device configured to acquire the pieces of return determination information from the return determination information acquisition device, to acquire the return determination conditions from the storage device, and to perform, based on the pieces of return determination information and the return determination conditions, the return determination of the vehicle to the car station,
wherein the control device is configured to determine that the vehicle has been returned to the car station when any of the return determination conditions is determined to be satisfied.

2. A control device configured to perform a return determination of a vehicle that is jointly used among users registered in advance to a car station, using a plurality of pieces of return determination information including position information of the vehicle, the position information being used for the return determination of the vehicle to the car station.

3. The control device according to claim 2, wherein:
the pieces of return determination information include information related to a connection between a charging device installed at the car station and the vehicle; and
when the charging device and the vehicle are connected, the vehicle is determined to have been returned to the car station.

4. The control device according to claim 2, wherein:
the pieces of return determination information include information related to a connection between a beacon installed at the car station and either an in-vehicle device mounted in the vehicle or a portable information terminal associated with the vehicle; and
when the beacon and either the in-vehicle device or the portable information terminal are connected, the vehicle is determined to have been returned to the car station.

5. The control device according to claim 2, wherein:
the pieces of return determination information include information related to past vehicle position information acquired by a positioning unit provided in the vehicle, and a direction of movement of the vehicle; and
based on the past vehicle position information and the direction of movement of the vehicle, when the vehicle is estimated to be within the car station at a time of return of the vehicle, the vehicle is determined to have been returned to the car station.

6. The control device according to claim 2, wherein:
the pieces of return determination information include position information of a portable information terminal associated with the vehicle; and
when the position information of the portable information terminal is within the car station, the vehicle is determined to have been returned to the car station.
